(19) United States
(12) Patent Application Publication
(10) Pub. No.: US 2005/0058766 A1
(43) Pub. Date: Mar. 17, 2005

(54) Anti-diabetic diet and method for providing a proportioned ground food

(76) Inventor: Chung Wan Han, Springfield, VA (US)

Correspondence Address: DITTHAVONG & CARLSON, P.C.;Suite A, 10507 Braddock Road, Fairfax, VA, 22032, US

(21) Appl. No.: 10/939,611

(22) Filed: Sep. 13, 2004

Related U.S. Application Data
(60) Provisional application No. 60/501,862, filed on Sep. 11, 2003.

(51) Int. Cl. A23G 3/00

(52) U.S. Cl. 426/658

(57) ABSTRACT

A method for achieving a versatile anti-diabetic diet and method for providing a viscous-high-fiber carbohydrate (CHO X) and a proportioned ground food ideally designed for a diabetic. The CHO X, according to one embodiment of the present invention, supports a delayed ingestion of carbohydrates to avoid glucose toxicity due to its natural viscosity characteristic and oil proof effect against permeability of carbohydrates in digestive system. A ground food is created based on the CHO X for pre-diabetic or diabetic patients. The ground food can be derived from three groups: a carbohydrate (CHO) group, a protein group, and a fat group. The CHO group can include glutinous rice and high fiber carbohydrates; these materials can be combined to result in a product denoted as CHO X. This new composition CHO X delays permeability of carbohydrates into a digestive system by controlling release of the carbohydrates.

The present application is related to the U.S. Provisional Patent Application Ser. No. 60/501,862, filed Sep. 11, 2003, entitled “Specially designed anti diabetic diet to improve diabetes control,” is incorporated herein by reference.

### FIELD OF THE INVENTION

The present invention relates to dietary products, and more particularly to an anti-diabetic diet.

### BACKGROUND OF THE INVENTION

Diabetes mellitus is a group of diseases characterized by high levels of blood glucose resulting from defects in insulin production, insulin action, or both. Diabetes can be associated with serious complications and premature death. Traditionally, diabetic treatments have been reactive, concentrating on treating the condition upon the onset of diabetes. It is recognized that pre-diabetes is a condition in which blood glucose levels are higher than normal, but not high enough for a diagnosis of diabetes. Controlling levels of blood glucose at the pre-diatetic state is important to prevention of diabetes.

Pre-diabetes and type 2 diabetes are known as non-insulin-dependent diabetes mellitus (NIDDM) or adult-onset diabetes. Type 2 diabetes is associated with older age, obesity, family history of diabetes, history of gestational diabetes, impaired glucose metabolism, physical inactivity, and race/ethnicity. Type 2 diabetes may account for about 90 percent to 95 percent of all diagnosed cases of diabetes.

Lifestyle changes can prevent or delay the onset of type 2 diabetes, and can include a change in diet with moderate-intensity physical activity as well as medications. However, despite development in anti-diabetics application and physiology base strategic approaches, such advancements are undermined by that fact that a large number of patients exhibit poor control of their diabetic condition in large part because they are unable to follow the calculated daily diet required for effective control of diabetes. That is, few patients are able to follow a proper anti-diabetic diet for every meal because the majority of the patients routinely miscalculate the proper proportion of ingredients for the recommended foods. Moreover, this majority prefer to consume foods of their own choice.

Because blood sugar rises after meals, the immediate need for insulin manufactured by the pancreas is highest shortly after such meals. Consequently, the immediate need for insulin is highest shortly at these times. In non-diabetics, the pancreas produces the correct amount of insulin needed to allow glucose to enter body cells. However, in diabetics, blood glucose can rapidly rise over 250 mg/dl after a meal because of the deficiency of insulin sensitivity of cells and glucose toxicity; this rise in blood glucose level is not properly controlled. To address this issue, the type 2 diabetic can eat sparingly, throughout the entire day, as to avoid big meals at any one time, thereby allowing the pancreas to more accurately determine the exact amount of insulin necessary. However, for many diabetics, this approach is not practical. For example, in a work environment, frequent breaks for meals is disruptive.

Accordingly, the need exists for a method of providing a diabetic to consume meals at regular meal times, typically three or four times a day, while maintaining control of the blood sugar level.

### SUMMARY OF THE INVENTION

These and other needs are addressed by the present invention in which a proportioned ground food is provided for diabetic and pre-diabetic patients. A method of providing the ground food for an anti-diabetic diet is disclosed in which the ground food comprises a viscous-high-fiber carbohydrate (CHO X) proportion ranges from 40-45%, a protein ranges from 25-30% and a 30% of fat. According to one embodiment of the present invention, the viscous-high-fiber carbohydrate (CHO X) can be formulated such that when ingested a delay of penetration of acid in the digestive system is achieved due to a natural elastic characteristic of the CHO X. This delay can be further achieved by insulating the CHO X through the use of an oil or fat based product to enhance the natural elastic characteristic of the CHO X. The insulating process can be utilized to control release of the CHO X into the body's digestive tract, thereby introducing the CHO X more slowly than otherwise possible. Additionally, the insulating process provides a viscous CHO X, which increases the time spent within the stomach and small intestines. Advantageously, the ground food retains the CHO X and other desirable proportions of proteins and fat that is ideally recommended proportions for diabetic patients are contained. With the ground food, food makers enable to make various food types and diabetic patients benefit without considering to follow complicated arranged meal table and subduing his/her appetite.

According to one aspect of the present invention, a method of providing a proportioned ground food for an anti-diabetic diet. The method includes generating a carbohydrate-based composition by combining a glutinous rice with a high fiber carbohydrate, wherein the carbohydrate-based composition exhibits a predetermined elastic characteristic and insulated with fat or oil. Also, the method includes granulating the carbohydrate-based composition; selecting and granulating a source of protein and selecting and granulating a source of fat. In addition, the method includes mixing the granulated carbohydrate-based composition, the granulated source of protein, and the granulated source of fat and determining whether the mixture exhibits a predetermined portion of carbohydrate, protein, and fat. Further, the method includes outputting the mixture as ground food.

According to one aspect of the present invention, a method for making a viscous-high-fiber carbohydrate (CHO X) is disclosed. The method includes mixing 35-50% of glutinous rice and 10-15% of high fiber carbohydrates. Also, the method includes placing a mixture into a pot and adding about 1 1/4 cup water for each cup of the mixture. In an exemplary embodiment, the mixture is submerged in water for about 24 hours until the mixture softens. In addition, the method includes boiling or steaming the mixture. Then, mixing fat or oil with the mixture. Further the method includes freeze and drying the mixture. The method includes granulating the mixture after the freeze and drying the mixture.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram showing a daily recommended proportion of food for anti-diabetic diet, in accordance with an embodiment of the present invention;

FIG. 2 is a diagram showing the making a ground food to prevent diabetes, according to an embodiment of the present invention;

FIG. 3 is a flowchart depicting the process of making a viscous-high-fiber carbohydrate (CHO X), according to an embodiment of the present invention;

FIG. 4 is a flowchart depicting the process of making a ground food, according to an embodiment of the present invention; and

FIG. 5 is a diagram depicting the relationship between time delay release of carbohydrate into the digestive system and CHO X, according to an embodiment of the present invention.

### DESCRIPTION OF THE PREFERRED EMBODIMENT

A method for providing a proportioned ground food for an anti-diabetic diet is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

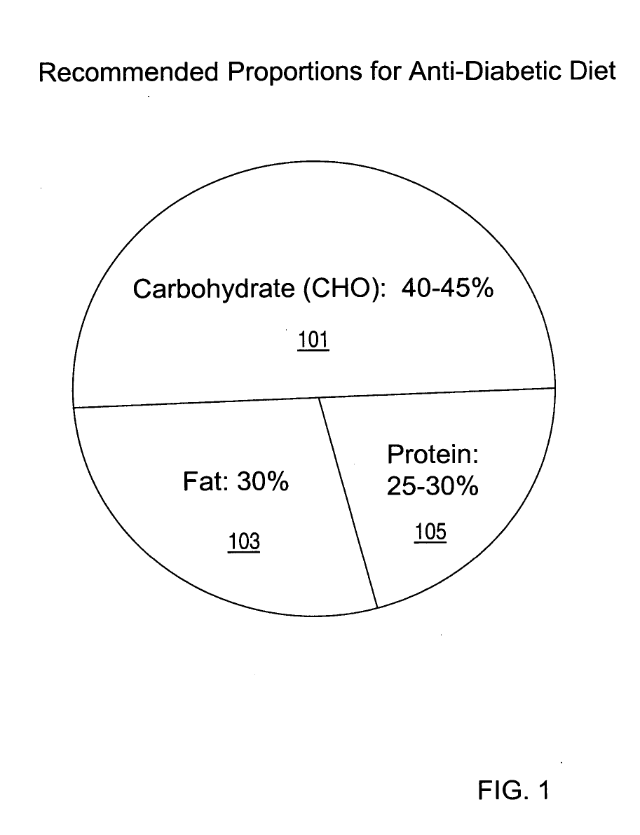

FIG. 1 is a diagram showing a daily recommended proportion of food for anti-diabetic diet, in accordance with an embodiment of the present invention. It is recognized that a desirable for an anti-diabetic diet comprises a carbohydrate (CHO) composition 101, a fat component 103, and a protein component 105. In one embodiment, the CHO proportion ranges from 40-45%, the protein from 25-30%, and the fat about 30%. It is noted that these proportions can vary slightly depending on the user. As discussed, these proportions are not easily obtained through conventional dietary approaches.

Since the aim of diabetic therapy is to prevent large fluctuations in blood glucose throughout the day, diabetics are advised to select carbohydrates foods that minimize the postprandial blood glucose excursions. Many methods of making an ideal multi-component carbohydrate food have been used by incorporating differing carbohydrate sources that are digested at differing rates. While these methods produce improved blood glucose levels after a meal, they are difficult to manufacture in volume, in part, because the inherent variability of natural material such as raw corn starch makes manufacturing difficulties.

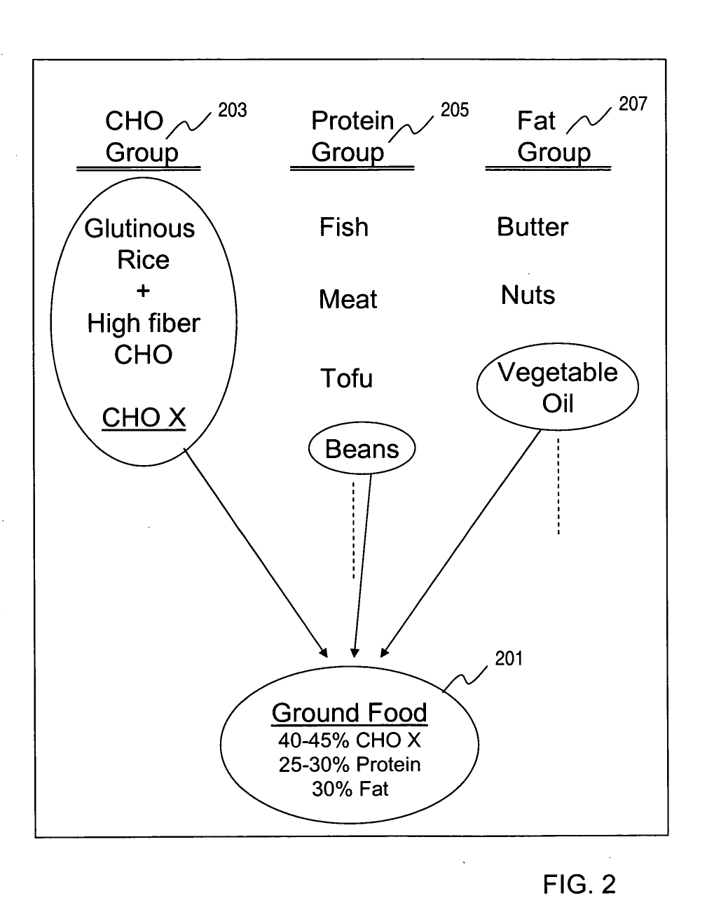

The present invention, according to one embodiment, achieves the recommended proportions of CHO, fat, and protein, as described below in FIGS. 2-5.

FIG. 2 shows a flowchart for a process for making ground food to prevent diabetes, in accordance with an embodiment of present system. As seen, ground food can be derived from the tree groups: CHO group 203, protein group 205, and fat group 207. By way of example, the CHO group 203 can include glutinous rice and high fiber carbohydrates such as oat, wheat, viscous gums, cellulose, mucilages and pectins; these materials can be combined to result in a product denoted as viscous-high-fiber carbohydrate (CHO X). This new composition of CHO X is used to avoid glucose toxicity, whereby a fat or oil insulating process causes a controlled delay of digestion. Within the protein group 205, such items are fish, meat, tofu, and beans are provided. The fat group 207 can include butter, nuts, and vegetable oil. It is contemplated that the various items in each of the groups 203, 205 and 207 can be tailored to a user according to the user's preferences. For example, the group items can be selected according to the type of cuisine preferred by the user, as certain items are more suitable to certain types of cuisine (e.g., rice is more prevalent in Asian dishes).

As mentioned, according to one embodiment of the present invention, CHO X can be formulated such that when ingested a delay of penetration of acid in the digestive system is introduced. This delay is achieved by insulating the CHO X against rapid absorption into digestive system using an oil based product to enhance the natural elastic characteristic of the CHO X and to protect from the acid. The insulating process can control release of the CHO X into the body's digestive tract, thereby introducing the CHO X more slowly than otherwise possible. Additionally, the insulating process provides a viscous CHO X, which increases the time spent within the stomach and small intestines. The CHO X can be readily mixed with the protein through, for example, a freezing process and subsequent granulization process, as explained below, to result in a base ground food for production of other foods or simply to supplement foods.

Advantageously, the ground food retains the three desirable proportions within a single product (ground food). Consequently, a food manufacturer can readily implement the desirable mixture of the CHO group 203, the protein group 205, and the fat group 207 for pre-diabetic and diabetic patients without incurring the time and expense to incorporate differing carbohydrate sources. Another advantage is that the food makers, from the ground food, are able to create various foods, such as cereals, noodles or ravioli, etc.

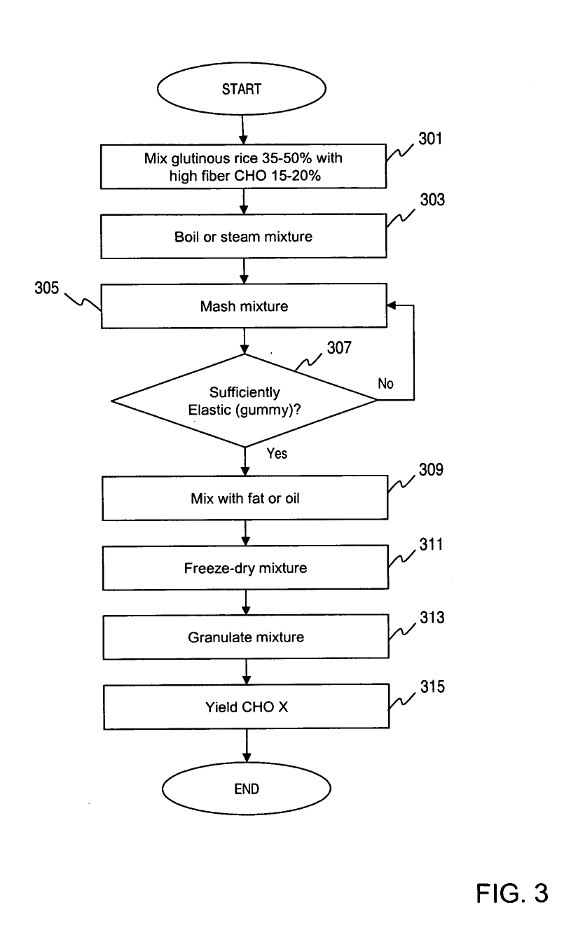

FIG. 3 is a flowchart depicting the process of making a CHO X, according to an embodiment of the present invention. By way of example, in step 301, glutinous (i.e., “sweet”) rice is mixed with high fiber carbohydrates (oat, wheat, viscous gums, cellulose, mucilages and pectins) and cooked in water in the following proportions: 35-50% of glutinous rice and 15-20% of rice or flour. Specifically, prior to mixing, users (e.g., food makers) need to wash both the glutinous rice and high fiber carbohydrates to purify the flavor and to remove any impurities. Next, the glutinous rice and high fiber carbohydrate (oat, wheat, viscous gums, cellulose, mucilages and pectins) are placed into a pot and water is added—about 1¼ cup water for each cup of the mixture. Subsequently, the mixture is submerged for about 24 hours until the rice and high fiber carbohydrates soften, and the water is drained.

In step 303, the rice mixture is then boiled (or steamed) until cooked. The boiling or steaming process will vary according to quantity. When heated, the rice mixture melts and exhibits a consistency of a thick piece of mozzarella cheese. For steaming, a conventional steam equipment designed to reach pressures of 2000-3000 lbs/sq. inch may be used.

In the mash process of the step 305, the cooked rice product can gain enhanced elastic characteristics, which affect digestion. That is, the elastic characteristic goes to delay penetration of the digestive acid. This property (i.e., “gumminess”) can be adjusted according to the desired delay. In step 307, the rice product is checked to determine with it is sufficiently elastic to achieve the target delay; if not, the steps 303 and 305 are repeated.

To further resist metabolic absorption, the gummy rice product is mixed with fat or oil, per step 309. The particular fat or oil can be chosen based on flavor. Examples of the raw material having excellent flavor include safflower oil, rapeseed oil, corn oil, soybean oil, olive oil, rice oil, purified palm oil, purified lard thereof and the like. The surface tension of the emulsifier-added fat or oil is not particularly limited, and those having a surface tension reduced to 20 mN/m (at 60° C.) or less are preferred, more preferably 10 mN/m (at 60° C.) or less. The amount of the emulsifier-added fat or oil added to the food is not particularly limited because the amount also differs depending upon the desired CHO X, however, the total oil should not exceed 10%.

The insulating process not only provides retention of oil within the gummy rice product during frozen storage, but also suppression of the adhesion of the products by among themselves, thereby making the foods more easily separable from each other after thawing and during cooking.

After coating with oil or fat, the rice product is freeze-dried, as in step 311. The freeze-dry process can be executed by a rapid freezing procedure (e.g., −60° C.). Thereafter, the freeze-dried rice product is stored in a freezer. The freeze-dry process 311 advantageously allows the rice mixture to be incorporated in a ground food from which use can obtain variety of foods while preserving the desired proportions.

In step 313, the freeze-dried rice mixture can be made into fine pieces through a granulating process. An exemplary embodiment, the size of the pieces can be varied depending on the application. For instance, the user can select the size of the pieces based both on time delay release of carbohydrate into the digestive system and characteristic of food forms in which it is administered by a food maker. After granulation, the CHO X is produced to formulate the desirable proportions of CHO, protein, and fat, per step 315.

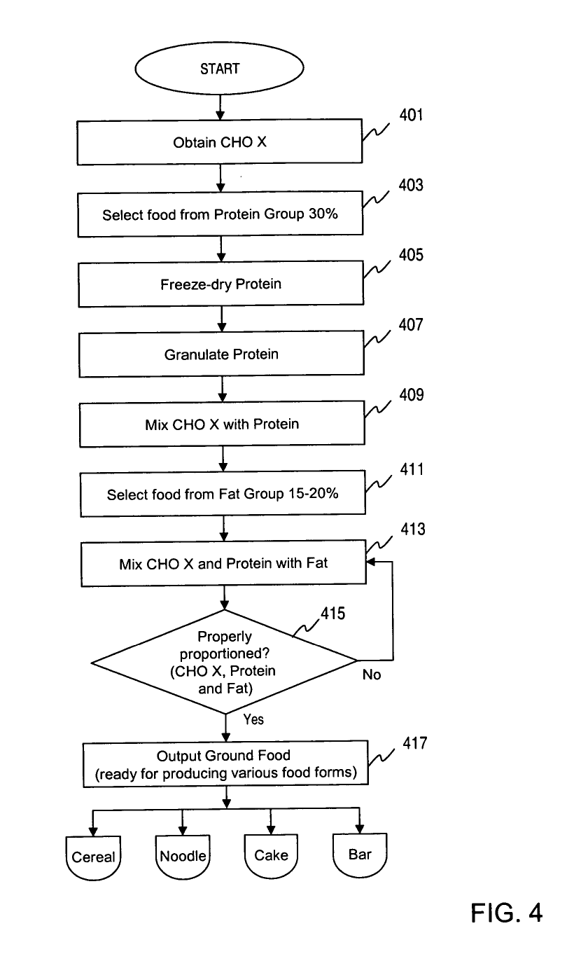

FIG. 4 is a flowchart depicting the process of making a ground food, according to an embodiment of the present invention. In step 401, CHO X is obtained using the process explained with respect to FIG. 3. Next, a user can select any types of food from protein group 205, as in step 403. The selected food can be varied based its availability to food makers (which can depend on the geographic region). After selection, the selected food (i.e., protein) then is placed into a dryer to undergo a freeze-dry process, per step 405. It is noted that any suitable dryer may be used according to the selected protein. For example, conventional dryers known in the trade as top-inlet dryers may be used. In the dryer, moisture in the selected protein is removed by evaporation. For long term storage, the selected protein is dried to a storage-stable moisture content. Whether the selected protein is intended to be stored or used immediately, the selected protein is dried to a moisture content so that upon granulation, the composition is not tacky so that the dried granules of the protein do not adhere to one another when the protein is mixed with the CHO X (per step 409). Generally, it is sufficient that the drying process yield a moisture content from about 7% to about 13%. For storage, a moisture content on the order of less than about 10% is acceptable.

During the drying process, the temperature is increased slowly. This very low temperature increase of the protein ensures that no appreciable denaturation of the protein content of the protein takes place. In other words, this is achieved solely as a consequence of the low and consequently gradual temperature increase to which the production is exposed during the processing and drying.

In an exemplary embodiment, the freeze-dry process of the selected food (i.e., protein concentrate) involves the SANDVIK™ belt freezing system. It is contemplated that other freeze-dry systems such as tray systems and ice slicer systems can also be used. In addition, a cold gas may be introduced during the freezing process, for example, air at a temperature of about −10° C. has been found to be suitable.

Next, the frozen protein concentrate, as in step 407, can be broken into pieces through granulating process, which can be conducted in a multistage breaking apparatus (such as a blender). The majority of the resultant particles of frozen protein concentrate can vary in size, ranging from about 2.4 mm to 3.3 mm; however, larger particles can also be present. It is noted that size variations are possible depending on the food types.

In step 413, the processed protein is ready to be mixed with the CHO X. Since the processed protein undergoes similar processes of CHO X, the combinability of two material is easily achieved.

Next, a user can select, as in step 411, any fat with a proper proportion of 15-20% from fat group 207, which is to be applied to the CHO X after mixing the selected fat with the selected protein based upon the weight of the composition.

After mixing the fat with CHO X and the processed protein, a user should determine whether the recommended proportions, as shown in FIG. 1, of the each group is obtained (per step 415). The ground food may comprise of, after the fat is employed, 45-50% of CHO X, 30% of protein and 25-30% of fat. The additional fat provides a protective effect against the permeability of carbohydrate into the digestive tract as well as protecting nutritive value of the protein when subjected to heat process, particularly when preparing various food styles by food makers. If the proportions are not proper, then step 413 is repeated. When the proportions are correct, a ground food is produced, per step 417. At this point, the ground found is ready for making various food formats, such as noodle, pasta, cereal, cake, nutrition bar, breads, bagels, biscuits, crackers and ravioli, etc.

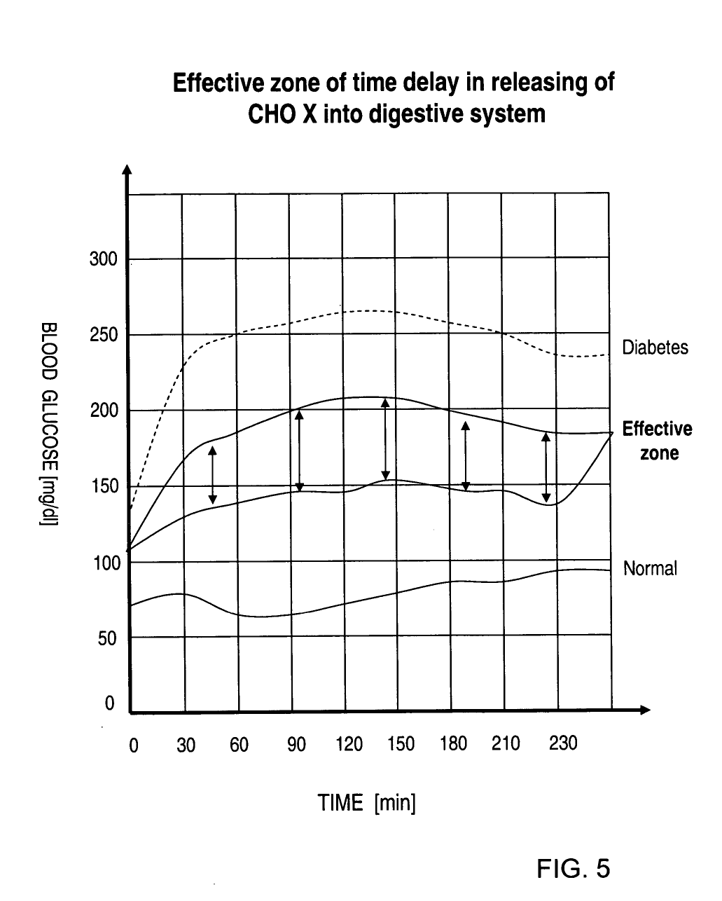

FIG. 5 illustrates an effective zone of time delay in releasing of CHO X into a human digestive system. The insulate property of the fat or oil as well as the natural viscous (gummy) characteristic, affects the release of the carbohydrate into digestive system. This control can be manipulated to decrease high index of blood glucose into the effective zone, thus, relieving severe blood metabolism disorders. The oral tolerance test (OGTT or GTT) depicted in the FIG. 5 is a diagnosis method for diabetes. The effective zone acquired by a delayed release action that is helpful in minimizing the effects of diabetes which is characterized by a glucose toxicity in the blood because of a deficiency or diminished effectiveness of insulin. It is observed that the graph is exemplary in nature, and may vary from person to person (and even from month to month).

Accordingly, the present invention provides targeted anti-diabetic food makers by enabling them to make various types of food with a ground food exhibiting the desired proportions of carbohydrate, protein, and fat.

While the present invention has been described in connection with a number of embodiments and implementations, the present invention is not so limited but covers various obvious modifications and equivalent arrangements, which fall within the purview of the appended claims.

1. A method of providing a proportioned ground food for an anti-diabetic diet, the method comprising:
generating a carbohydrate-based composition by combining a glutinous rice with a high fiber carbohydrate, wherein the carbohydrate-based composition exhibits a predetermined elastic characteristic and insulated with fat or oil;
granulating the carbohydrate-based composition;
selecting and granulating a source of protein;
selecting and granulating a source of fat;
mixing the granulated carbohydrate-based composition, the granulated source of protein, and the granulated source of fat;
determining whether the mixture exhibits a predetermined portion of carbohydrate, protein, and fat; and
outputting the mixture as ground food.

2. A method according to the claim 1, wherein the high fiber carbohydrate includes oat, wheat, viscous gums, cellulose, mucilages or pectins.

3. A method according to the claim 1, wherein the insulation with fat or oil is measured to control permeability index of the high fiber carbohydrate into a human digestive system.

4. A method according to the claim 1, wherein the predetermined portion specifies about 40-45% carbohydrate, about 20-30% protein, and about 30% fat.

5. A method according to the claim 1, wherein the ground food is used to create a noodle, a pasta, a cereal, a cake, a nutrition bar, a bread, a bagel, a biscuit, or a cracker.

6. A method for creating a viscous-high-fiber carbohydrate (CHO X), the method comprising the steps of:
mixing a glutinous rice with a high fiber carbohydrate, wherein the mixture is about 35-50% glutinous rice and about 10-15% high fiber carbohydrate;
adding about 1¼ cup water for each cup of the mixture;
boiling or steaming the mixture;
adding fat or oil with the mixture;
freeze-drying the mixture; and
granulating the mixture.

7. A method according to the claim 6, wherein the high fiber carbohydrate includes oat, wheat, viscous gums, cellulose, mucilages or pectins.

8. A method according to the claim 6, further comprising:
submerging the mixture in water until the mixture softens to a predetermined threshold.

9. A method according to the claim 8, wherein the mixture is submerged for 24 hours.

10. A method according to the claim 6, wherein the mixture is boiled according to a pressure range from about 1.2 bar to about 3.5 bar overpressure.

11. A method according to the claim 6, wherein the mixed is steamed according to a temperature range of about 100° C. to about 200° C.

12. A method according to the claim 6, wherein the addition of fat or oil is regulated to inhibit release of the carbohydrate into a human digestive system.

13. A method according to the claim 6, wherein the freeze-drying step is performed according a temperature range from about −10° C. to about −60° C.

14. A method according to the claim 6, wherein the granulated mixture includes portions each having a size ranging from about 2.0 mm to about 10.0 mm.

15. A method according to the claim 6, wherein the granulated mixture includes portions having a size based on a time delay release of carbohydrate into a human digestive system and a food form.

16. A ground food for an anti-diabetic diet, the food comprising:
a carbohydrate-based composition including a glutinous rice and a high fiber carbohydrate, wherein the carbohydrate-based composition exhibits a predetermined elastic characteristic and insulated with fat or oil, the high fiber carbohydrate being selected from a group consisting of oat, wheat, viscous gums, cellulose, mucilages and pectins, the carbohydrate-based composition is granulated and covered with fat or oil in predetermined amount to control permeability index of the high fiber carbohydrate into a human digestive system;
a granulated source of protein; and
a granulated source of fat, wherein the ground food exhibits a proportion about 40-45% carbohydrate, about 20-30% protein, and about 30% fat.
